(19) United States
(12) Patent Application Publication
(10) Pub. No.: US 2022/0051147 A1
(43) Pub. Date: Feb. 17, 2022

(54) INFORMATION PROCESSING APPARATUS AND NON-TRANSITORY COMPUTER READABLE MEDIUM STORING INFORMATION PROCESSING PROGRAM

(71) Applicant: FUJIFILM Business Innovation Corp., Tokyo (JP)

(72) Inventor: Kengo TOKUCHI, Kanagawa (JP)

(73) Assignee: FUJIFILM Business Innovation Corp., Tokyo (JP)

(21) Appl. No.: 17/155,102

(22) Filed: Jan. 22, 2021

(30) Foreign Application Priority Data
Aug. 13, 2020 (JP) 2020-136742

(51) Int. Cl. G06Q 10/02; G06Q 30/02; G06Q 50/30; G01C 21/34

(52) U.S. Cl. CPC G06Q 10/02; G01C 21/3407; G06Q 50/30; G06Q 30/0282

(57) ABSTRACT

An information processing apparatus includes: a processor configured to acquire a free time occurring since a point in time at which a user starts moving toward a destination point until a target job is started at the destination point; and perform control of presenting an available space for the free time in a case where the free time is equal to or longer than a predetermined time.

### CROSS-REFERENCE TO RELATED APPLICATIONS

This application is based on and claims priority under 35 USC 119 from Japanese Patent Application No. 2020-136742 filed Aug. 13, 2020.

### BACKGROUND

### (i) Technical Field

The present invention relates to an information processing apparatus, and a non-transitory computer readable medium storing an information processing program.

### (ii) Related Art

JP2019-207118A discloses an information processing apparatus which searches for a second path instead of a first path in a case where a guidance process of the first path is started in response to a request for path guidance and it is detected that a user terminal which is a request source of the path guidance is delayed from the first path. This information processing apparatus acquires at least a start time of a first schedule, which is the purpose of the movement by the first path, and a first location associated with the first schedule, and determines whether or not the first location can be reached within the start time with movement by the second path. In addition, this information processing apparatus outputs information on the second path and information indicating whether or not the movement by the second path can arrive at the first location by the start time.

JP2005-122675A discloses a system in which a person who provides a bicycle of the person used as a transportation means at a station to a train user as a shared bicycle which can be used by an unspecified number of members (hereafter, simply referred to as a bicycle) is set as a member of the system. This system causes a portable terminal having a card reader to input or monitor unique information on the member and the bicycle, information such as a bicycle use status, information on delivery of the bicycle at a relay bicycle parking in front of the station, or the like. In addition, this system collectively manages the information by a computer at an information management center via a relay computer by wire or wirelessly.

### SUMMARY

As described above, in the related art, the method of effectively using a transportation means for the user to arrive at a destination point from a departure point is disclosed. Meanwhile, the above method has a problem that a free time occurring before an arrival at the destination point cannot be effectively used.

Aspects of non-limiting embodiments of the present disclosure relate to an information processing apparatus and a non-transitory computer readable medium storing an information processing program that can usefully use a free time occurring before an arrival at a destination point.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including: a processor configured to acquire a free time occurring since a point in time at which a user starts moving toward a destination point until a target job is started at the destination point; and perform control of presenting an available space for the free time in a case where the free time is equal to or longer than a predetermined time.

### BRIEF DESCRIPTION OF THE DRAWINGS

Exemplary embodiment(s) of the present invention will be described in detail based on the following figures, wherein:

FIG. 1 is a block diagram illustrating an example of a hardware configuration of an information processing system according to an exemplary embodiment;

FIG. 2 is a block diagram illustrating an example of a functional configuration of the information processing apparatus according to the exemplary embodiment;

FIG. 3 is a schematic diagram illustrating an example of a configuration of a movement information database according to the exemplary embodiment;

FIG. 4 is a schematic diagram illustrating an example of a configuration of a failure information database according to the exemplary embodiment;

FIG. 5 is a schematic diagram illustrating an example of a configuration of a reservation information database according to the exemplary embodiment;

FIG. 6 is a schematic diagram illustrating an example of a configuration of a user information database according to the exemplary embodiment;

FIG. 7 is a schematic diagram illustrating an example of a configuration of a facility information database according to the exemplary embodiment;

FIG. 8 is a schematic diagram illustrating an example of a configuration of a spatial information database according to the exemplary embodiment;

FIG. 9 is a schematic diagram illustrating an example of a configuration of a parking lot information database according to the exemplary embodiment;

FIG. 10 is a schematic diagram illustrating an example of a configuration of a baggage storage information database according to the exemplary embodiment;

FIG. 11 is a flowchart illustrating an example of an information process according to the exemplary embodiment;

FIG. 12 is a flowchart illustrating an example of a presentation space determination process according to a first exemplary embodiment;

FIG. 13 is a front view illustrating an example of a configuration of a priority condition selection screen according to the exemplary embodiment;

FIG. 14 is a front view illustrating an example of a configuration of a space presentation screen according to the exemplary embodiment;

FIG. 15 is a front view illustrating an example of a configuration of a baggage information input screen according to the exemplary embodiment;

FIG. 16 is a front view illustrating an example of a configuration of a baggage storage presentation screen according to the exemplary embodiment;

FIG. 17 is a flowchart illustrating an example of a presentation space determination process according to a second exemplary embodiment;

FIG. 18 is a front view illustrating an example of a configuration of an available time presentation screen according to the exemplary embodiment;

FIG. 19 is a front view illustrating an example of a configuration of a use fee presentation screen according to the exemplary embodiment;

FIG. 20 is a front view illustrating an example of a configuration of a distance presentation screen according to the exemplary embodiment;

FIG. 21 is a front view illustrating an example of a configuration of an exercise information presentation screen according to the exemplary embodiment; and

FIG. 22 is a front view illustrating an example of a configuration of a reserved-people number presentation screen according to the exemplary embodiment.

### DETAILED DESCRIPTION

Hereinafter, exemplary embodiments of the present invention will be described in detail with reference to the accompanying drawings.

### First Exemplary Embodiment

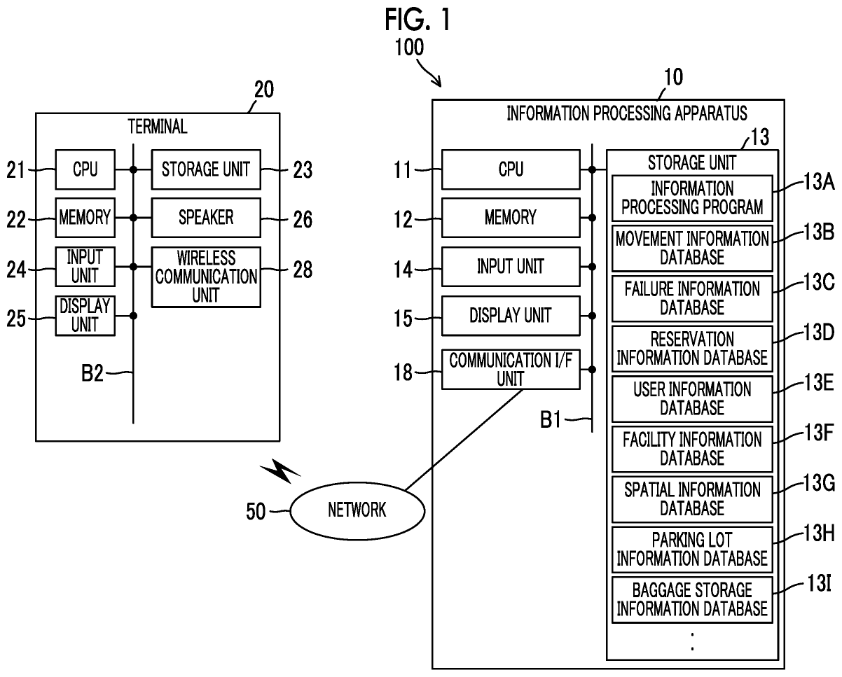

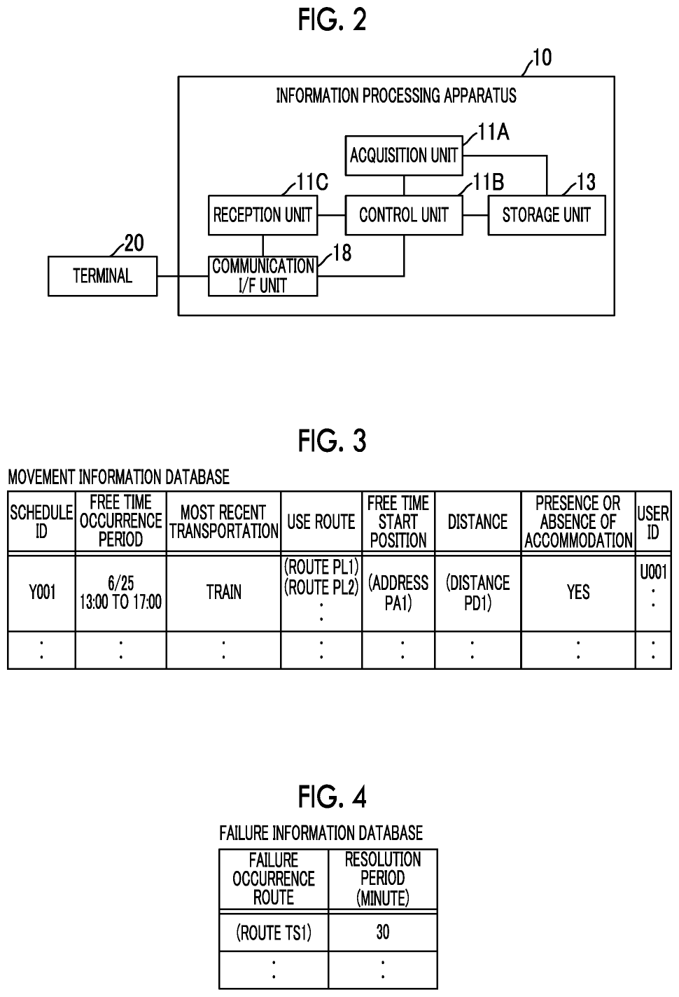

First, a configuration of an information processing system 100 according to the present exemplary embodiment will be described with reference to FIGS. 1 and 2. As illustrated in FIG. 1, the information processing system 100 according to the present exemplary embodiment includes an information processing apparatus 10 and a terminal 20 which can respectively access to a network 50.

In the present exemplary embodiment, a personal computer is applied as the information processing apparatus 10, but another information processing apparatus such as a server computer may be applied. Further, in the present exemplary embodiment, a smartphone is applied as the terminal 20, but other terminals such as a tablet terminal and a notebook type personal computer may be applied.

The information processing apparatus 10 according to the present exemplary embodiment includes a Central Processing Unit (CPU) 11, a memory 12 as a temporary storage area, a non-volatile storage unit 13, an input unit 14 such as a keyboard and a mouse, a display unit 15 such as a liquid crystal display, and a communication interface (I/F) unit 18. The CPU 11, the memory 12, the storage unit 13, the input unit 14, the display unit 15, and the communication I/F unit 18 are connected to each other via a bus B1.

The storage unit 13 is realized by a hard disk drive (HDD), a solid state drive (SSD), a flash memory, or the like. An information processing program 13A is stored in the storage unit 13 as a storage medium. The CPU 11 reads the information processing program 13A from the storage unit 13 and expands the information processing program 13A into the memory 12, and sequentially executes processes included in the information processing program 13A.

Further, a movement information database 13B, a failure information database 13C, a reservation information database 13D, and a user information database 13E are stored in the storage unit 13. Further, the storage unit 13 stores a facility information database 13F, a spatial information database 13G, a parking lot information database 13H, and a baggage storage information database 13I. Details of these databases will be described below.

On the other hand, the terminal 20 according to the present exemplary embodiment is an apparatus possessed by a user (hereinafter, simply referred to as a “target user”) who uses a space of an available location by using the information processing system 100. In the present exemplary embodiment, a work booth which can be used by one person or a plurality of people by dividing the users for each specific period is applied as the space, but the space is not limited to this mode. For example, as the above space, a work booth installed in the form of a private room, a seat of a store such as a car, a restaurant or a coffee shop, a conference room, a convenience store, a seat of a resting space in the city, a parking lot, a bicycle parking lot, or the like may be applied. Further, the user heads to a space to be used after making a reservation for a candidate location to be used in advance, but the space may be used without reservation.

The terminal 20 includes a CPU 21, a memory 22 as a temporary storage area, a non-volatile storage unit 23, an input unit 24 such as a touch panel, a display unit 25 such as a liquid crystal display, a speaker 26, and a wireless communication unit 28. The CPU 21, the memory 22, the storage unit 23, the input unit 24, the display unit 25, the speaker 26, and the wireless communication unit 28 are connected to each other via a bus B2. Further, the storage unit 23 is realized by an HDD, an SSD, a flash memory, or the like.

Next, a functional configuration of the information processing apparatus 10 according to the present exemplary embodiment will be described with reference to FIG. 2. As illustrated in FIG. 2, the information processing apparatus 10 according to the present exemplary embodiment includes an acquisition unit 11A, a control unit 11B, and a reception unit 11C. By executing the information processing program 13A, the CPU 11 of the information processing apparatus 10 functions as the acquisition unit 11A, the control unit 11B, and the reception unit 11C.

The acquisition unit 11A according to the present exemplary embodiment acquires a free time (hereinafter, simply referred to as a “free time”) which occurs since a point in time at which the target user starts moving toward a destination point until a target job (hereinafter, simply referred to as a “schedule”) is started at the destination point. In the present exemplary embodiment, the free time is acquired by reading the free time from the movement information database 13B described below.

Further, in a case where the free time is equal to or more than a predetermined time, the control unit 11B according to the present exemplary embodiment performs control of presenting a space which can be used in the free time (hereinafter, simply referred to as “available space”). In the present exemplary embodiment, the terminal 20 is controlled to present the available space via the communication I/F unit 18. Further, in the present exemplary embodiment, as the predetermined time, a preset time is applied by an administrator of the information processing apparatus 10 (hereinafter, simply referred to as an “administrator”), and the present exemplary embodiment is not limited thereto. For example, as the predetermined time, a time automatically determined for each target user according to a frequency or the like at which the target user presents a space to the terminal 20 may be applied.

Further, in the present exemplary embodiment, as the available space, a space which can be used by all the target users for a predetermined time or longer by the administrator or the target user or the like is applied, but the space is not limited thereto. For example, as the available space, a space which can be used by all the target users may be simply applied.

Further, in a case where a plurality of the above spaces exist, the control unit 11B according to the present exemplary embodiment determines the spaces to be presented to the terminal 20 according to a recommendation degree of the spaces.

In particular, in the present exemplary embodiment, as the recommendation degree, a degree determined according to the most recent transportation means until the free time occurs is applied. In the present exemplary embodiment, a transportation means such as a railroad, an airplane, a bus, and an automobile are applied as the transportation means, but the present exemplary embodiment is not limited thereto. For example, in addition to the above transportation means, movement by foot may be included, or a single or a combination of a plurality of transportation means may be applied.

Further, in the present exemplary embodiment, as the recommendation degree, a degree determined according to a time during which the target user can use the space (hereinafter, simply referred to as “available time”) is also applied. In the present exemplary embodiment, the longer the available time is, the higher the recommendation degree is, but the recommendation degree is not limited to this. For example, as the recommendation degree, the shorter the available time, the higher the degree may be applied, or the recommendation degree automatically determined for each target user according to a time in a case where the target user used the space in the past may be applied.

Further, in the present exemplary embodiment, as the recommendation degree, a degree according to a distance from a position of the target user at a point in time in a case where the free time occurs (hereinafter, simply referred to as a “free time start position”) to the space is determined and applied. In the present exemplary embodiment, a movement distance from the free time start position to the space is applied as the distance, but a straight line distance from the free time start position to the space may be applied. Further, in the present exemplary embodiment, as the recommendation degree, the shorter the distance, the higher the degree is applied, but the present exemplary embodiment is not limited thereto. For example, as the recommendation degree, the longer the distance, the higher the degree may be applied, or the recommendation degree automatically determined for each target user according to the above distance in a case where the target user used the space in the past may be applied.

Further, in the present exemplary embodiment, as the recommendation degree, a degree determined according to an exercise intensity or the amount of exercise (hereinafter, simply referred to as “exercise information”) of the target user required to arrive at the space is also applied. In the present exemplary embodiment, as the recommendation degree, the higher the exercise intensity required to arrive at the space or the larger the amount of exercise, the higher the degree is applied, but the present exemplary embodiment is not limited thereto. For example, as the recommendation degree, the lower the exercise intensity or the smaller the amount of exercise, the higher the degree may be applied, or depending on the exercise information in a case where the target user used the space in the past, the recommendation degree automatically determined for each target user may be applied.

Further, in the present exemplary embodiment, the exercise intensity or the amount of exercise of the target user required from the free time start position to an arrival at the space is applied as the exercise information, but the present exemplary embodiment is not limited thereto. For example, as the exercise information, the exercise intensity or the amount of exercise of the target user required from a departure point departing for the destination point to the arrival at the space may be applied.

Further, in the present exemplary embodiment, as the exercise intensity, a ratio of an energy consumption amount in a case where the exercise is performed to an energy consumption amount at rest, which is preset for each corresponding exercise, is applied, but the present exemplary embodiment is not limited thereto. For example, as the exercise intensity, a ratio of a heart rate in a case where the exercise is performed to a heart rate at rest, which is preset for each corresponding exercise and for each target user, may be applied. Further, in the present exemplary embodiment, a product of the exercise intensity corresponding to the corresponding exercise and the time during which the exercise is executed is applied as the amount of exercise, but the present exemplary embodiment is not limited thereto. For example, as the amount of exercise, in addition to the exercise intensity corresponding to the corresponding exercise and the time for executing the exercise, a value obtained by accounting a weight of the heaviest person among the target users may be applied. Further, in the present exemplary embodiment, it is assumed that the amount of exercise increases proportionally as the exercise intensity increases.

Further, in the present exemplary embodiment, as the recommendation degree, a degree determined according to a use fee of the space is also applied. In the present exemplary embodiment, as the recommendation degree, the lower the use fee, the higher the degree is applied, but the present exemplary embodiment is not limited thereto. For example, as the recommendation degree, the higher the use fee, the higher the degree may be applied, and a recommendation degree automatically determined for each target user according to the use fee in a case where the target user used the space in the past may be applied.

Further, in the present exemplary embodiment, a degree determined according to the number of users for the space expected at a point in time at which the target user arrives at the space (hereinafter, simply referred to as “number of reserved-people”) is also applied as the recommendation degree. In the present exemplary embodiment, the lower the number of reserved-people is, the higher the recommendation degree is applied as the recommendation degree, but the recommendation degree is not limited thereto. For example, as the above recommendation degree, the higher the number of reserved-people, the higher the degree may be applied, or a recommendation degree automatically determined for each target user according to the number of users of the space in a case where the target user used the space in the past may be applied. Further, in the present exemplary embodiment, the number of people who reserve the space in the free time is applied as the number of reserved-people, but the number of people is not limited thereto. For example, as the number of reserved-people, an average number of people in the space in a time slot corresponding to the free time may be applied.

Further, in the present exemplary embodiment, as the above recommendation degree, a degree determined according to an attributes of the target user is applied. In the present exemplary embodiment, an occupation is applied as the above attribute, and in a case where there is a target user of which occupation is a company employee, a degree determined according to service availability for the company employee, which will be described below, is applied as the recommendation degree, but the present exemplary embodiment is not limited thereto. For example, the presence or absence of physical disability is applied as the above attribute, and as the above recommendation degree, in a case where there is a target user with physical disability, the degree determined depending on whether or not the facility has barrier-free facilities such as elevators and dotted blocks may be applied. In addition, an age may be applied as the above attribute, and in a case where there is a target user of a minor, a degree determined according to availability of the minor user may be applied as the recommendation degree.

Further, in the present exemplary embodiment, as the above recommendation degree, a degree determined according to the number of target users (hereinafter, simply referred to as “number of users”) is also applied. In the present exemplary embodiment, as the above recommendation degree, in a case where the number of users is one, a degree determined according to availability of private rooms is applied, but the present exemplary embodiment is not limited thereto. For example, as the above recommendation degree, a degree determined according to the number of desks available to all the target users may be applied.

Further, in the present exemplary embodiment, as the recommendation degree, a degree determined according to an occurrence situation of traffic congestion until the free time occurs, and a degree determined according to an occurrence situation of an accident until the free time occurs are applied. In the present exemplary embodiment, as the recommendation degree, a degree determined according to a time obtained by subtracting a period expected (hereinafter, referred to as a “resolution period”) to be required until at least one of the traffic congestion or the accident (hereinafter, referred to as a “failure”) is resolved from the free time is applied.

Further, in the present exemplary embodiment, in a case where an administrator presents the above space as a business and there is a facility which benefits the administrator (hereinafter, simply referred to as a “facility”), a degree determined according to a distance between the facility and the space is applied as the recommendation degree. In the present exemplary embodiment, as the recommendation degree, the shorter the distance between the facility and the space, the higher the degree is applied, but the present exemplary embodiment is not limited thereto. For example, a recommendation degree automatically determined for each target user according to the distance between the facility and the space used by the target user more frequently than a predetermined frequency may be applied.

Further, in the present exemplary embodiment, in a case where the facility exists, a degree determined according to a magnitude of the profit by the facility is applied, as the recommendation degree. In the present exemplary embodiment, as the recommendation degree, the shorter the distance between the facility and the space at which the profit is equal to or larger than a predetermined profit, the higher the degree is applied, but the present exemplary embodiment is not limited thereto. For example, as the recommendation degree, the shorter the distance between the facility and the space at which an increase rate of the profit is equal to or higher than a predetermined increase rate, the higher the degree may be applied.

Further, the reception unit 11C according to the present exemplary embodiment further receives selection of a condition for the space from the target user from the terminal 20 via the communication I/F unit 18. In the present exemplary embodiment, the available time, a distance from the free time start position to the space, the exercise intensity or the amount of exercise, the use fee, and the number of reserved-people are applied as the above conditions, but the present exemplary embodiment is not limited thereto. For example, as the above condition, a condition indicating the presence or absence of a service for company employees, which will be described below, a condition indicating whether or not a vending machine is installed in the space, and the like may be applied, or a single or a combination of a plurality of conditions may be applied.

In addition, the control unit 11B according to the present exemplary embodiment determines the space to be presented according to the selection.

Further, in a case where a predetermined condition is satisfied, in addition to presenting the space, the control unit 11B according to the present exemplary embodiment causes the terminal 20 to further present a baggage storage at which a distance to the space is within a predetermined distance via the communication I/F unit 18. In the present exemplary embodiment, a coin locker for the purpose of profit is applied as the baggage storage, but the present exemplary embodiment is not limited thereto. For example, a non-profit baggage storage may be applied as the baggage storage.

In particular, in the present exemplary embodiment, as the predetermined condition, a condition that the distance between the destination point and the departure point is equal to or greater than the predetermined distance is applied. In the present exemplary embodiment, a distance preset by the administrator is applied as the predetermined distance, but the distance is not limited to this mode. For example, a distance preset by the target user may be applied as the predetermined distance, or a distance automatically determined for each target user according to a distance or the like between the destination point and the departure point in a case where the target user presented the baggage storage in the past may be applied.

Further, in the present exemplary embodiment, as the above predetermined condition, a condition that the attribute of the target user is a predetermined attribute and a condition that accommodation is accompanied with a movement to the destination point may be also applied. In the present exemplary embodiment, the age is applied as the above attribute, but an attribute such as the presence or absence of physical disability or the presence or absence of pregnancy may be applied.

Further, in the present exemplary embodiment, as the above predetermined condition, a condition that a weight of a baggage brought by the target user is equal to or more than a predetermined weight is also applied. In the present exemplary embodiment, a weight preset by the administrator is applied as the predetermined weight, but the present exemplary embodiment is not limited thereto. For example, the weight preset by the target user may be applied as the predetermined weight, or a weight automatically determined for each target user according to a weight of the baggage in a case where the target user presented the baggage storage in the past may be applied.

Further, in the present exemplary embodiment, as the predetermined condition, a condition that a size of the baggage brought by the target user is equal to or larger than a predetermined dimension is also applied. In the present exemplary embodiment, a dimension preset by the administrator is applied as a predetermined dimension, but the present exemplary embodiment is not limited thereto. For example, as the predetermined dimension, a dimension preset by the target user may be applied, or a dimension automatically determined for each target user according to a dimension of the baggage in a case where the target user presented the baggage storage in the past may be applied.

Further, in the present exemplary embodiment, a length of the baggage, a width of the baggage, and a height of the baggage are applied as the dimensions of the baggage, and as the above predetermined condition, a condition that there is one or more of dimensions having a size equal to or larger than the predetermined dimension is applied, but the present exemplary embodiment is not limited thereto. For example, as the predetermined condition, a condition that there are two or more of dimensions having a size equal to or larger than the predetermined dimension may be applied, or a threshold value for each dimension may be determined. In addition, as the dimension of the baggage, a single or a combination of the length of the baggage, the width of the baggage, and the height of the baggage may be applied.

Further, in the present exemplary embodiment, as the above predetermined condition, a condition that the baggage brought by the target user includes a preset type of item is also applied. In the present exemplary embodiment, a precision machine such as a personal computer or a video camera is applied as the above predetermined type, but a glass product, pottery, or the like may be applied.

Further, the reception unit 11C according to the present exemplary embodiment receives a reservation for the space from the target user according to the presentation of the space from the terminal 20 via the communication I/F unit 18.

Further, in a case where the reception unit 11C receives the reservation, the control unit 11B according to the present exemplary embodiment further performs a process of validating the reservation for the space by the target user. In the present exemplary embodiment, as the process of validating the reservation, a process of storing information on the space to be reserved in the reservation information database 13D, which will be described below, is applied by the control unit 11B.

In addition, the control unit 11B according to the present exemplary embodiment controls the terminal 20 to further present a way to the space via the communication I/F unit 18. In the present exemplary embodiment, as information indicating the way to the space, a map information illustrating the way from the free time start position to the space is applied, but the present exemplary embodiment is not limited thereto. For example, as the information indicating the way to the space, a text information indicating the way from the departure point to the space may be applied.

In the present exemplary embodiment, a presentation method by the display unit 25 is applied as the presentation method of various information by the terminal 20, but the present exemplary embodiment is not limited thereto, and for example, a presentation method or the like with a voice by the speaker 26 may be applied as the presentation method.

Next, various databases according to the present exemplary embodiment will be described with reference to FIGS. 3 to 10. A database other than the movement information database 13B and the failure information database 13C is a database constructed by the administrator. First, the movement information database 13B according to the present exemplary embodiment will be described with reference to FIG. 3.

The movement information database 13B is a database obtained by receiving a departure point, a departure time, a destination point, and a time at which the above schedule is started, which are input by the target user with the terminal 20 or the like, by constructing with the information processing apparatus 10 or the like based on information obtained by using a movement path search system known in the related art from the received information. Here, in order to avoid complications, a path from the departure point to the destination point is searched as the shortest path by the movement path search system.

As illustrated in FIG. 3, the movement information database 13B according to the present exemplary embodiment stores information such as a schedule identification (ID), a free time occurrence period, a most recent transportation means, a use route, a free time start position, a distance, the presence or absence of accommodation, and a user ID in association with each other.

The schedule ID is information given in advance as information different for each schedule in order to individually specify the schedule, and the free time occurrence period is information indicating a period of the free time. Here, in order to avoid complications, it is assumed that only one free time occurrence period occurs for each corresponding schedule. Further, in the present exemplary embodiment, as the free time, a time from a point in time of arrival at a relay point from the departure point to the destination point to a start of the next movement is applied.

The most recent transportation means is information indicating the most recent transportation means until the corresponding free time starts, and the use route is information indicating a route used from the departure point to the free time start position in the corresponding schedule. The free time start position is information indicating the free time start position described above, and the distance is information indicating a movement distance from the departure point to the destination point in the corresponding schedule. The presence or absence of accommodation is information indicating the presence or absence of accommodation in the corresponding schedule, and the user ID is information given in advance as information different for each target user in order to individually specifying the target user in the corresponding schedule.

The example illustrated in FIG. 3 indicates that for example, until a schedule to which Y001 is assigned as the schedule ID is started, from 13:00 to 17:00 on June 25th, a free time of 4 hours occurs at an address PA1 (actually, a specific address), the most recent transportation means until the free time occurs is a train, and routes used before the free time occurs are route PL1 and route PL2 (actually, names of specific routes). Further, the example illustrated in FIG. 3 indicates that for example, the schedule to which Y001 is assigned as the schedule ID is a schedule of the target user to which U001 is assigned as the user ID, a distance from the destination point to the departure point is a distance PD1, and accommodation is accompanied.

Next, the failure information database 13C according to the present exemplary embodiment will be described. In the present exemplary embodiment, the failure information database 13C is a database which the information processing apparatus 10 sequentially updates based on information provided by Japan Road Traffic Information Center and the like. As illustrated in FIG. 4, the failure information database 13C according to the present exemplary embodiment stores information on a failure occurrence route and a resolution period in association with each other.

The failure occurrence route is information indicating a route on which a failure occurs, and the resolution period is information indicating the resolution period corresponding to the corresponding failure occurrence route. In the example illustrated in FIG. 4, for example, it is expected that it will take 30 minutes for the above failure occurring on a failure occurrence route TS1 (actually, a name of a specific route) to be resolved.

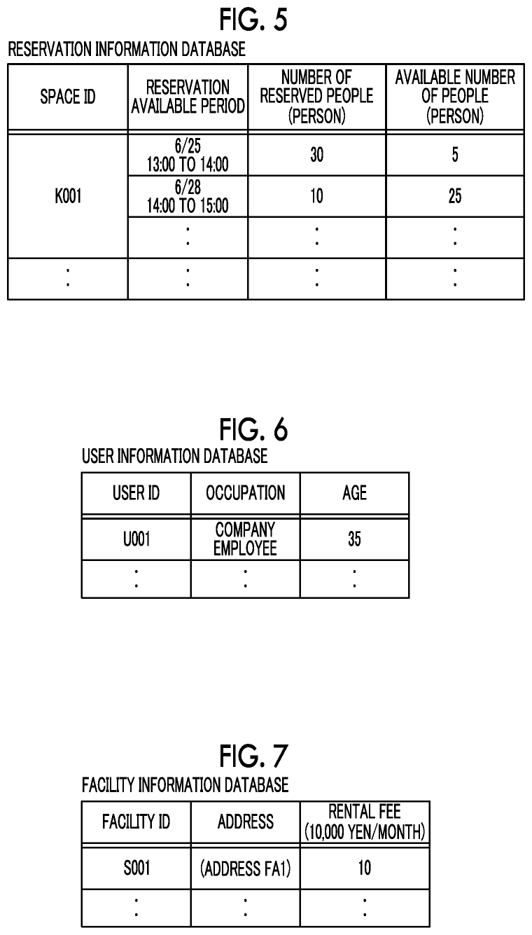

Next, the reservation information database 13D according to the present exemplary embodiment will be described. As illustrated in FIG. 5, the reservation information database 13D according to the present exemplary embodiment stores information on a space ID, a reservation available period, the number of reserved-people, and the available number of people in association with each other.

The space ID is information given in advance as information different for each space in order to individually specify the space, and the reservation available period is information indicating a period during which the corresponding space can be reserved. The number of reserved-people is information indicating the number of people reserved in the corresponding space during the corresponding reservation available period, and the available number of people is information indicating the number of people available in the corresponding space during the corresponding reservation available period.

In the example illustrated in FIG. 5, for example, a space to which K001 is assigned as the space ID is reserved to be used by 30 people from 13:00 to 14:00 on June 25, and can be used by up to 5 people.

Next, the user information database 13E according to the present exemplary embodiment will be described. As illustrated in FIG. 6, the user information database 13E according to the present exemplary embodiment stores information on a user ID, an occupation, and an age in association with each other.

The user ID is the same information as the user ID in the movement information database 13B. The occupation is information indicating an occupation of the corresponding target user, and the age is information indicating an age of the corresponding target user. In the example illustrated in FIG. 6, for example, the occupation of the target user to whom U001 is assigned as the user ID is a company employee, and the age is 35 years old.

Next, the facility information database 13F according to the present exemplary embodiment will be described. As illustrated in FIG. 7, the facility information database 13F according to the present exemplary embodiment stores information on a facility ID, an address, and a rental fee in association with each other.

The facility ID is information given in advance as information different for each facility in order to individually specify the facility, the address is information indicating an address of the corresponding facility, and the rental fee is information indicating a rental fee paid for the corresponding facility to the administrator. In the example illustrated in FIG. 7, for example, an address corresponding to the facility to which 5001 is assigned as the facility ID is an address FA1 (actually, a specific address), and 100,000 yen per month is paid to the administrator.

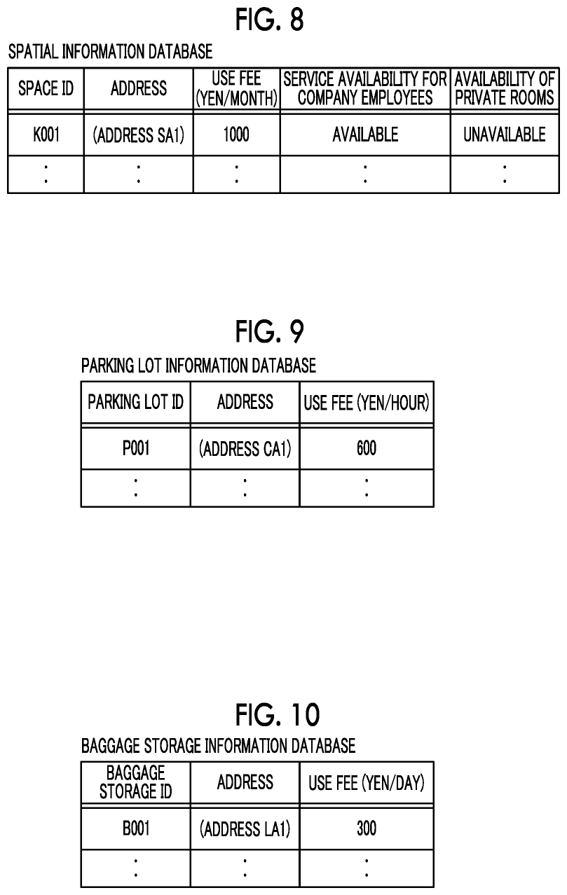

Next, the spatial information database 13G according to the present exemplary embodiment will be described. As illustrated in FIG. 8, the spatial information database 13G according to the present exemplary embodiment stores information on a space ID, an address, a use fee, service availability for company employees, and availability of private rooms in association with each other.

The space ID is the same information as the space ID in the reservation information database 13D, the address is information indicating an address of the corresponding space, and the use fee is information indicating a use fee of the corresponding space. The service availability for company employees is information indicating whether or not a service for company employees can be used in the corresponding space, and the availability of private rooms is information indicating whether or not a private room can be used in the corresponding space. In the present exemplary embodiment, a service of providing a desk light, a power outlet, and a wireless local area network (LAN) is applied as the service for company employees, but the present exemplary embodiment is not limited thereto. For example, as the service for company employees, a service of providing a private room provided with a soundproof sheet may be applied, or a single or a combination of a plurality of these services may be applied. Further, in the present exemplary embodiment, as the private room, a box-shaped private room of which surroundings are only covered with walls, doors, ceilings, or the like is applied, and a private room which is only partitioned by a partition or the like may be applied. In the example illustrated in FIG. 8, for example, an address corresponding to the space to which K001 is assigned as the space ID is an address SA1 (actually, a specific address), and the use fee per day is 1000 yen. Further, in the example illustrated in FIG. 8, for example, in a space to which K001 is assigned as the space ID, the service for company employees can be used, but the private room cannot be used.

Next, the parking lot information database 13H according to the present exemplary embodiment will be described. As illustrated in FIG. 9, the parking lot information database 13H according to the present exemplary embodiment stores information on a parking lot ID, an address, and a use fee in association with each other.

The parking lot ID is information given in advance as information different for each parking lot in order to individually specify the parking lot, and the address is information indicating an address of the corresponding parking lot, and the use fee is information indicating a use fee of the corresponding parking lot. In the example illustrated in FIG. 9, for example, an address corresponding to the parking lot to which P001 is assigned as the parking lot ID is an address CA1 (actually, a specific address), and the use fee per hour is 600 yen.

Next, the baggage storage information database 13I according to the present exemplary embodiment will be described. As illustrated in FIG. 10, the baggage storage information database 13I according to the present exemplary embodiment stores information on a baggage storage ID, an address, and a use fee in association with each other.

The baggage storage ID is information given in advance as information different for each baggage storage in order to individually specify the baggage storage. The address is information indicating an address of the corresponding baggage storage, and the use fee is information indicating a use fee of the corresponding baggage storage. In the example illustrated in FIG. 10, for example, an address corresponding to the baggage storage to which B001 is assigned as the baggage storage ID is an address LA1 (actually, a specific address), and the use fee per day is 300 yen.

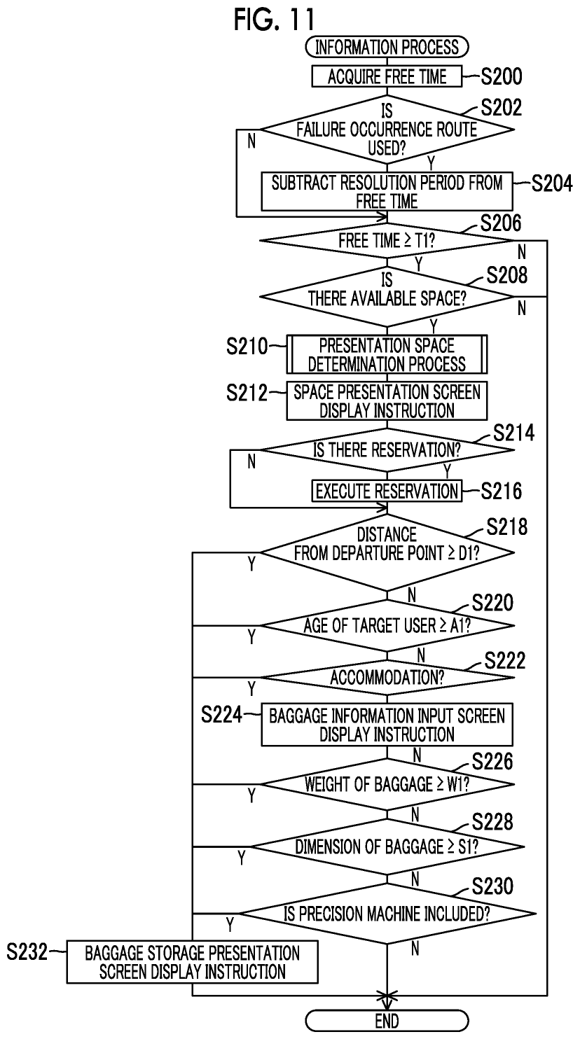

Next, an operation of the information processing apparatus 10 will be described. In the information processing system 100 according to the present exemplary embodiment, in a case where any target user gives an information processing execution instruction by using the terminal 20 before departure for performing any schedule, the CPU 11 of the information processing apparatus 10 executes the information processing program 13A, so that the information process indicated in FIG. 11 is executed. Here, in order to avoid complications, a case where a database other than the reservation information database 13D is constructed in advance will be described.

In step S200 in FIG. 11, the CPU 11 reads a free time occurrence period corresponding to a schedule to be processed (hereinafter, referred to as a “target schedule”) from the movement information database 13B, and acquires a free time from the free time occurrence period. With the present process, for example, the movement information database 13B is illustrated in FIG. 3, and in a case of a schedule having the schedule ID of Y001, 4 hours are acquired as the free time.

In step S202, the CPU 11 determines whether or not to use a failure occurrence route. More specifically, first, the CPU 11 reads a use route corresponding to the target schedule from the movement information database 13B, and reads the failure occurrence route from the failure information database 13C. Next, the CPU 11 determines whether or not to use the failure occurrence route by determining whether or not the read failure occurrence route includes the route to be used. The CPU 11 proceeds to step S204 in a case where a positive determination is made in the process in step S202, and proceeds to step S206 in a case where a negative determination is made.

In step S204, the CPU 11 sets a period obtained by subtracting the resolution period from the acquired free time, as the free time. More specifically, first, the CPU 11 reads a resolution period corresponding to the corresponding failure occurrence route from the failure information database 13C. Next, the CPU 11 updates a start time of the free time in the free time occurrence period read in the process in step S200 by shifting the start time by the read resolution period. For example, the movement information database 13B is illustrated in FIG. 3 and the failure information database 13C is illustrated in FIG. 4, and in a case of a schedule having the schedule ID of Y001, the start time of the free time is updated at 13:30 on June 25th.

In step S206, the CPU 11 determines whether or not the free time obtained through the above processes is equal to or longer than a predetermined time T1. In a case where a positive determination is made in the process in step S206, the CPU 11 proceeds to step S208, and in a case where a negative determination is made, it is assumed there is no space to be presented and the CPU 11 ends the present information process.

In step S208, the CPU 11 determines whether or not there is an available space. More specifically, first, the CPU 11 refers to the movement information database 13B and counts the number of users from the user ID corresponding to the target schedule.

Next, the CPU 11 refers to the reservation information database 13D and calculates an available period, which is a reservation available period included in the free time occurrence period corresponding to the target schedule, to acquire the available time for each space. For example, the movement information database 13B is illustrated in FIG. 3 and the reservation information database 13D is illustrated in FIG. 4, and in a case of an schedule having the schedule ID of Y001, the available period of the space of which the space ID is K001 is from 13:00 to 14:00 on June 25, and the available time is 1 hour.

Next, the CPU 11 determines whether or not there is an available space by referring to the reservation information database 13D and determining whether or not there is a space in which the number of available users is equal to or greater than the above number of users and the available time corresponding to the target schedule is equal to or longer than a predetermined time T2. In a case where a positive determination is made in the process in step S208, the CPU 11 proceeds to step S210, and in a case where a negative determination is made, it is assumed there is no space to be presented and the CPU 11 ends the present information process.

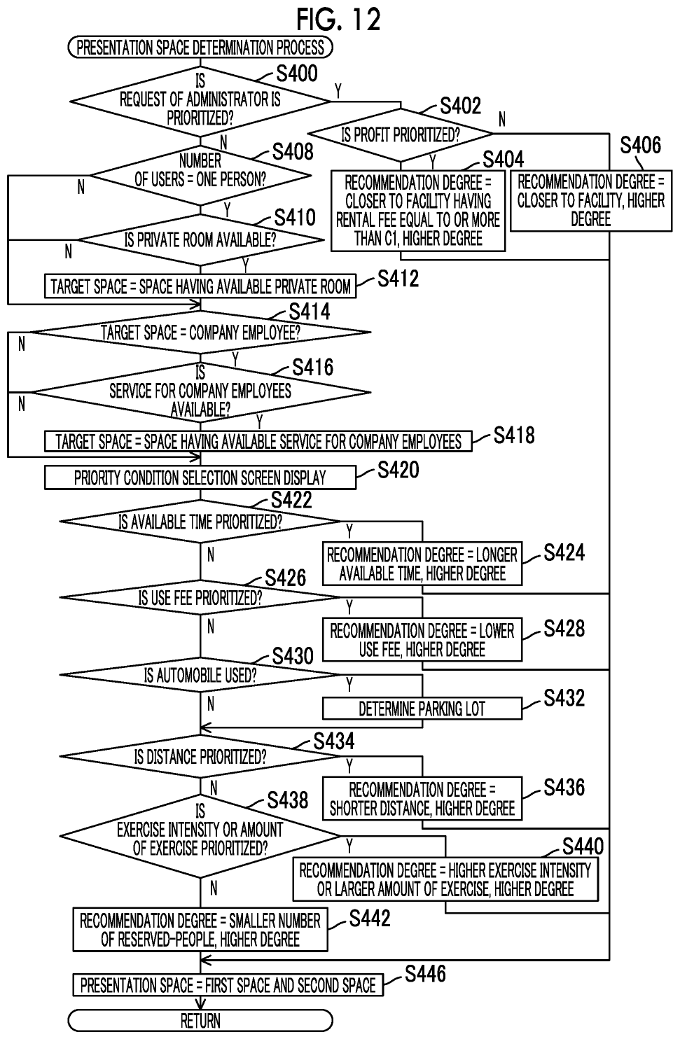

In step S210, the CPU 11 executes a presentation space determination process, which is a process for determining a space to be displayed on the display unit 25 of the terminal 20 as an access source among the available spaces obtained by the above process (hereafter, simply referred to as a “presentation space”.). Hereinafter, the presentation space determination process according to the present exemplary embodiment will be described with reference to FIG. 12. Here, in order to avoid complications, a case where there are a plurality of available spaces and the number of presentation spaces is two will be described.

Further, in the information processing system 100 according to the present exemplary embodiment, information indicating whether a request of the administrator or a request of the target user is prioritized (hereinafter, referred to as “request information”) is stored in the storage unit 13. In the information processing system 100 according to the present exemplary embodiment, in a case where the request of the administrator is prioritized, information indicating whether a profit of the administrator is prioritized or closeness of a distance between the facility and the space is prioritized (hereinafter, “priority information”) is stored in the storage unit 13. Further, in the present exemplary embodiment, a mode in which the administrator registers the request information and the priority information in advance is applied, but the present exemplary embodiment is not limited to this mode.

In step S400 in FIG. 12, the CPU 11 reads request information from the storage unit 13, determines whether or not the request information indicates that a request of the administrator is prioritized, and in a case where a positive determination is made, the CPU 11 proceeds to step S402 and in a case where a negative determination is made, the CPU 11 proceeds to step S408.

In step S402, the CPU 11 reads priority information from the storage unit 13, determines whether or not the priority information indicates that a profit of the administrator is prioritized, and in a case where a positive determination is made, the CPU 11 proceeds to step S404 and in a case where a negative determination is made, the CPU 11 proceeds to step S406.

In step S404, the CPU 11 reads all information from the facility information database 13F and the spatial information database 13G, sets the recommendation degree to a higher degree as the available space closer to the facility having a rental fee equal to or more than a predetermined rental fee Cl, and proceeds to step S446.

In step S406, the CPU 11 sets the recommendation degree to a higher degree as the available space closer to any facility regardless of the rental fee from the information read by the process in step S404, and proceeds to step S446.

On the other hand, in step S408, the CPU 11 determines whether or not the number of users obtained by the process in step S208 is one, and in a case where a positive determination is made, the CPU 11 proceeds to step S410 and in a case where a negative determination is made, the CPU 11 proceeds to step S414.

In step S410, the CPU 11 reads information indicating the availability of private rooms from the spatial information database 13G, and determines whether or not there is a space in which an available private room exists among the available spaces. In a case where a positive determination is made in the process in step S410, the CPU 11 proceeds to step S412, and in a case where a negative determination is made, the CPU 11 proceeds to step S414.

In step S412, the CPU 11 updates the space in which the available private room exists, as the available space, among the available spaces, by using the information indicating the availability of private rooms read by the process in step S410.

In step S414, the CPU 11 reads the user information database 13E, reads the occupation corresponding to the user ID read by the process in step S208, and determines whether or not the occupation includes the target user of the company employee. The CPU 11 proceeds to step S416 in a case where a positive determination is made in the process in step S414, and proceeds to step S420 in a case where a negative determination is made.

In step S416, the CPU 11 reads information indicating the service availability for company employees from the spatial information database 13G, and determines whether or not there is a space in which the service for company employees can be used among the available spaces. The CPU 11 proceeds to step S418 in a case where a positive determination is made in the process in step S416, and proceeds to step S420 in a case where a negative determination is made.

In step S418, the CPU 11 updates the space in which the service for the company employee can be used among the available spaces as the available space by using the information indicating the service availability for company employees read by the process in step S416.

In step S420, the CPU 11 controls the display unit 25 as an access source terminal 20 to display a priority condition selection screen in a predetermined format.

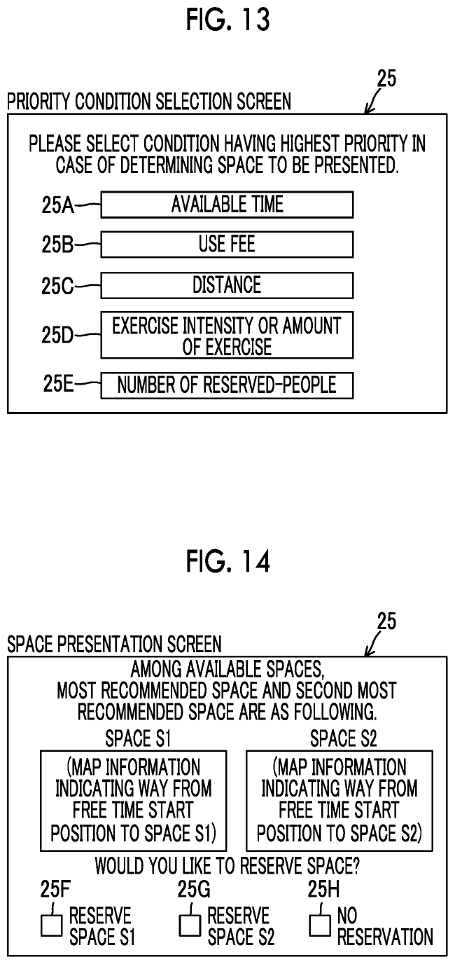

As illustrated in FIG. 13, on the priority condition selection screen according to the present exemplary embodiment, a message prompting selection of a condition having the highest priority in a case where a presentation space is determined from the available space is displayed. Further, on the priority condition selection screen according to the present exemplary embodiment, as conditions to be prioritized by the target user, a selection designation area 25A for selecting an available time, a selection designation area 25B for selecting a use fee, respectively, a selection designation area 25C for selecting a distance from a free time start position to an available space, a selection designation area 25D for selecting an exercise intensity or the amount of exercise, and a selection designation area 25E for selecting the number of reserved-people are respectively displayed. In a case where the priority condition selection screen illustrated in FIG. 13 as an example is displayed on the display unit 25 of the terminal 20 owned by the target user, the target user selects a selection designation area corresponding to a necessary condition from the selection designation areas 25A to 25E via the input unit 24. In the present exemplary embodiment, a mode in which only one priority condition can be selected by the target user is applied on the priority condition selection screen, but a mode in which two or more priority conditions can be selected may be applied.

In step S422, the CPU 11 determines whether or not the selection designation area 25A is selected on the priority condition selection screen, and in a case where a positive determination is made, the CPU 11 proceeds to step S424 and in a case where a negative determination is made, the CPU 11 proceeds to step S426.

In step S424, the CPU 11 sets the recommendation degree to a higher degree as the available space acquired by the process in step S208 has a longer available time, and proceeds to step S446.

In step S426, the CPU 11 determines whether or not the selection designation area 25B is selected on the priority condition selection screen, and in a case where a positive determination is made, the CPU 11 proceeds to step S428, and in a case where a negative determination is made, the CPU 11 proceeds to step S430.

In step S428, the CPU 11 reads a use fee corresponding to the available space from the spatial information database 13G, sets the recommendation degree to a higher degree as the available space has a lower use fee, and proceeds to step S446.

In step S430, the CPU 11 reads information indicating the most recent transportation means from the movement information database 13B, determines whether or not the most recent transportation means is an automobile, and in a case where a positive determination is made, the CPU 11 proceeds to step S432, and in a case where a negative determination is made, the CPU 11 proceeds to step S434.

In step S432, the CPU 11 determines a parking lot for parking the automobile used by the target user most recently until the free time occurs. More specifically, the CPU 11 reads a free time start position corresponding to the target schedule from the movement information database 13B, reads an address from the parking lot information database 13H, and determines a parking lot of which the address is closest to the read free time start position as the parking lot. Further, in step S432, the CPU 11 updates the read free time start position to the address corresponding to the determined parking lot.

In the present exemplary embodiment, the parking lot closest to the free time occurrence position is applied as the parking lot, but the present exemplary embodiment is not limited thereto. For example, as the parking lot, a parking lot in which a distance from the free time occurrence position is less than or equal to a predetermined distance and a use fee is the lowest may be applied.

Further, in the present exemplary embodiment, in the process in step S430, the CPU 11 determines whether or not the most recent transportation means is the automobile, but the present exemplary embodiment is not limited thereto. For example, in the process, the CPU 11 may apply a mode of determining whether or not the most recent transportation means is a bicycle or a motorcycle. In this case, in the process in step S432, since the CPU 11 needs to determine a bicycle parking lot for parking the bicycle or the motorcycle, the storage unit 13 stores a database storing information for individually specifying the bicycle parking lot, an address of the bicycle parking lot, or the like.

In step S434, the CPU 11 determines whether or not the selection designation area 25C is selected on the priority condition selection screen, and in a case where a positive determination is made, the CPU 11 proceeds to step S436, and in a case where a negative determination is made, the CPU 11 proceeds to step S438.

In step S436, the CPU 11 reads an address corresponding to the available space from the spatial information database 13G, and sets the recommendation degree to a higher degree as a movement distance from the free time start position to the address is shorter, and proceeds to step S446.

In step S438, the CPU 11 determines whether or not the selection designation area 25D is selected on the priority condition selection screen, and in a case where a positive determination is made, the CPU 11 proceeds to step S440 and in a case where a negative determination is made, the CPU 11 proceeds to step S442.

In step S440, the CPU 11 reads an address corresponding to the available space from the spatial information database 13G, sets the recommendation degree to a higher degree as the available space requires a higher exercise intensity or a larger amount of exercise from the free time start position to the arrival at the space, and proceeds to step S446.

In step S442, the CPU 11 reads the number of reserved-people corresponding to the available space from the reservation information database 13D, sets the recommendation degree to a higher degree as the number of reserved-people is smaller, and proceeds to step S446.

In step S446, the CPU 11 sets the presentation space as a first space, which is the most recommended space among the available spaces, and a second space, which is the second most recommended space among the available spaces, and ends the present presentation space determination process. In a case where the presentation space determination process is ended, the CPU 11 proceeds to step S212 for the information process (see FIG. 11).

In step S212, the CPU 11 controls the display unit 25 of the terminal 20 as an access source to display a space presentation screen in a predetermined format.

As illustrated in FIG. 14, on the space presentation screen according to the present exemplary embodiment, information indicating the first space and the second space (in the example illustrated in FIG. 14, “space S1” and “space S2”) and information indicating a way to each of the above spaces (map information in the example illustrated in FIG. 14) are displayed. Further, on the space presentation screen according to the present exemplary embodiment, a message prompting selection of whether or not to reserve the first space and the second space and a selection designation area 25F for selection in a case where the first space is reserved are displayed. Further, on the space presentation screen according to the present exemplary embodiment, a selection designation area 25G for selection in a case where the second space is reserved and a selection designation area 25H for selection in a case where neither the first space nor the second space is reserved are displayed. In a case where the space presentation screen illustrated in FIG. 14 as an example is displayed on the display unit 25, the target user selects a necessary selection designation area from the selection designation areas 25F to 25H via the input unit 24.

In step S214, the CPU 11 determines whether or not the selection designation area 25F or the selection designation area 25G is selected on the space presentation screen, and in a case where a positive determination is made, the CPU 11 proceeds to step S216, and in a case where a negative determination is made, the CPU 11 proceeds to step S218.

In step S216, the CPU 11 performs a process of validating the reservation of the space selected on the space presentation screen (hereinafter, simply referred to as “selected space”). Specifically, the CPU 11 refers to the reservation information database 13D, subtracts the number of users from the available number of people corresponding to the available period corresponding to the selected space, and adds the number of users to the number of reserved-people corresponding to the available period corresponding to the selected space.

In step S218, the CPU 11 reads a distance corresponding to the target schedule from the movement information database 13B, and determines whether or not the distance is equal to or greater than a predetermined distance D1. The CPU 11 proceeds to step S232 in a case where a positive determination is made in the process in step S218, and proceeds to step S220 in a case where a negative determination is made.

In step S220, the CPU 11 reads an age corresponding to the user ID read by the process in step S208 from the user information database 13E, and determines whether or not there is a target user having an age equal to or more than a predetermined age A1. The CPU 11 proceeds to step S232 in a case where a positive determination is made in the process in step S220, and proceeds to step S222 in a case where a negative determination is made.

In step S222, the CPU 11 reads presence or absence of accommodation corresponding to the target schedule from the movement information database 13B, and determines whether or not accommodation is accompanied with the target schedule. The CPU 11 proceeds to step S232 in a case where a positive determination is made in the process in step S222, and proceeds to step S224 in a case where a negative determination is made.

In step S224, the CPU 11 controls the display unit 25 to display a baggage information input screen in a predetermined format.

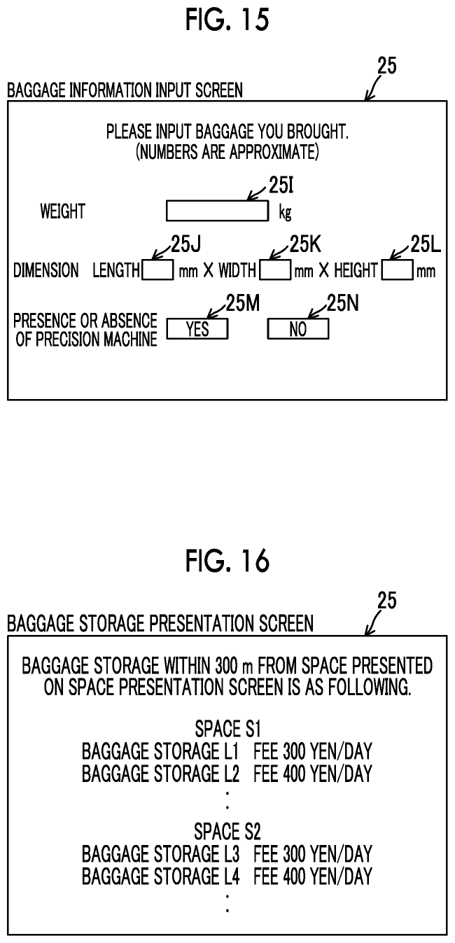

As illustrated in FIG. 15, on the baggage information input screen according to the present exemplary embodiment, a message prompting the target user to input approximate values of a weight and a dimension of a baggage to be brought and to select the presence or absence of precision machine is displayed. Further, on the baggage information input screen according to the present exemplary embodiment, an input area 25I for inputting the weight of the baggage, an input area 25J for inputting a length of the baggage, and an input area 25K for inputting a width of the baggage, and an input area 25L for inputting a height of the baggage are displayed. Further, on the baggage information input screen according to the present exemplary embodiment, a selection designation area 25M for selection in a case where the baggage includes the precision machine, and a selection designation area 25N for selection in a case where the baggage does not include the precision machine are displayed. In a case where the baggage information input screen illustrated in FIG. 15 as an example is displayed on the display unit 25 owned by the target user, the target user inputs all of the input areas 251 to 25L via the input unit 24 and selects the selection designation area 25M or the selection designation area 25N.

In step S226, the CPU 11 reads the storage unit 13 and determines whether or not the weight input to the input area 251 is equal to or greater than a predetermined weight W1, and in a case where a positive determination is made, the CPU 11 proceeds to step S232, and in a case where a negative determination is made, the CPU 11 proceeds to step S228.

In step S228, the CPU 11 reads the storage unit 13 and determines whether or not at least one of the dimensions input to the input area 25J, the input area 25K, and the input area 25L is equal to or greater than a predetermined dimension S1. The CPU 11 proceeds to step S232 in a case where a positive determination is made in the process in step S228, and proceeds to step S230 in a case where a negative determination is made.

In step S230, the CPU 11 determines whether or not the selection designation area 25M is selected on the baggage information input screen, ends the present information process in a case where a negative determination is made, and proceeds to step S232 in a case where a positive determination is made.

In step S232, the CPU 11 controls to display a baggage storage presentation screen in a predetermined format on the display unit 25 of the terminal 20 as an access source. Specifically, first, the CPU 11 reads addresses corresponding to the first space and the second space from the spatial information database 13G. Next, the CPU 11 refers to the baggage storage information database 13I, generates the baggage storage presentation screen by using the baggage storage ID and the use fee corresponding to the address within a predetermined distance D2 from the read address, and performs control of displaying the baggage storage presentation screen on the display unit 25.

As illustrated in FIG. 16, on the baggage storage presentation screen according to the present exemplary embodiment, information indicating a name and a use fee of a baggage storage within the predetermined distance D2 (300 meters in the example illustrated in FIG. 16) from the space presented on the space presentation screen is displayed. In a case where the process in step S232 is ended, the CPU 11 ends the present information process.

### Second Exemplary Embodiment

In the first exemplary embodiment, the case where selection of detailed conditions corresponding to conditions for the space is not received by the target user is described, but in the present exemplary embodiment, a case where the selection of the detailed conditions is received by the target user will be described.

Since a hardware configuration of the information processing apparatus 10 and a functional configuration of the information processing apparatus 10 according to the present exemplary embodiment are identical with the configuration according to the first exemplary embodiment (see FIGS. 1 and 2), description thereof will be omitted.

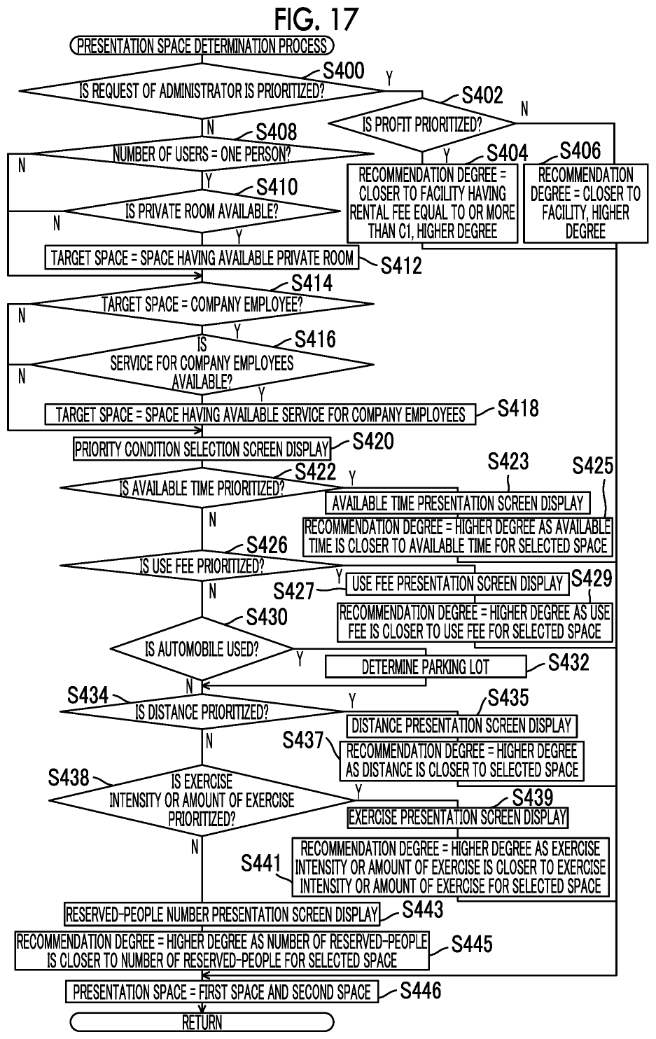

Next, with reference to FIG. 17, as an operation of the information processing apparatus 10 according to the present exemplary embodiment, an operation of the information processing apparatus 10 in a case where an information process is executed will be described. The information processing according to the present exemplary embodiment differs only in the presentation space determination process from the information processing according to the first exemplary embodiment. In the presentation space determination process illustrated in FIG. 17, the steps for executing a process identical with the presentation space determination process illustrated in FIG. 12 have identical step numbers with FIG. 12, and the description thereof will be omitted.

The presentation space determination process illustrated in FIG. 12 and the presentation space determination process illustrated in FIG. 17 are different from each other in that the processes in steps 423 and 425 are applied instead of the process in step S424, and the processes in steps S427 and 429 are applied instead of the process in steps S428. Further, the difference is that the processes in steps 435 and 437 are applied instead of the process in step S436, and the processes in steps 439 and 441 are applied instead of the process in step S440. Further, the different is that the processes in steps 443 and 445 are applied instead of the process in step S442.

That is, in step S423 in FIG. 17, the CPU 11 controls the display unit 25 to display an available time presentation screen in a predetermined format.

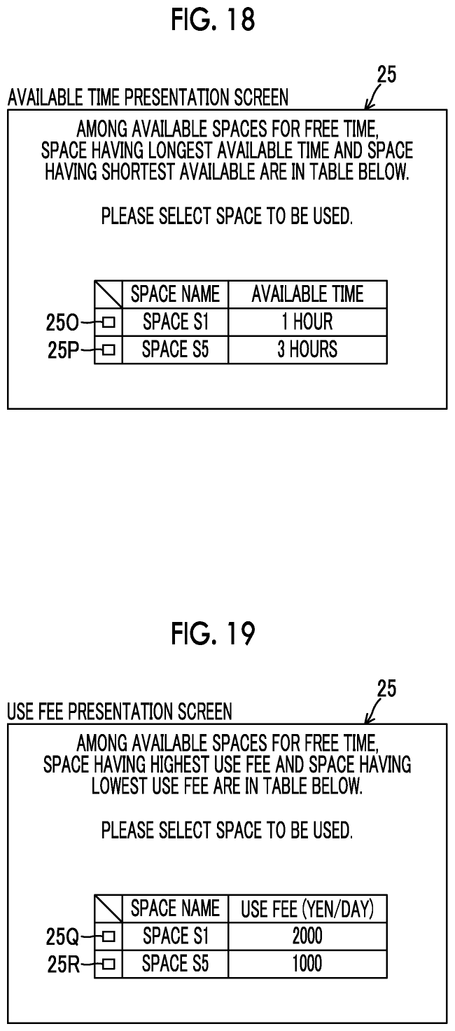

As illustrated in FIG. 18, on the available time presentation screen according to the present exemplary embodiment, information indicating names of a space having the longest available time and a space having the shortest available time among the available spaces, and the available times, and a message prompting selection of the space to be used among the spaces is displayed. Further, on the available time presentation screen according to the present exemplary embodiment, a selection designation area 25O and a selection designation area 25P for selecting each space are displayed. In a case where the available time presentation screen illustrated in FIG. 18 as an example is displayed on the display unit 25, the target user selects the selection designation area 250 or the selection designation area 25P via the input unit 24. With this selection, the CPU 11 may designate (grasp) whether the long time is requested or the short time is requested in a case where the target user gives priority to the available time of the available space.

In step S425, the CPU 11 sets the recommendation degree to a higher degree as the available time acquired in the process in step S208 is closer to the available time of the space selected on the available time presentation screen, and proceeds to step S446.

In step S427, the CPU 11 controls the display unit 25 to display a use fee presentation screen in a predetermined format.

As illustrated in FIG. 19, on the use fee presentation screen according to the present exemplary embodiment, information indicating names of a space having the highest use fee and a space having the lowest use fee among the available spaces, and the use fees, and a message prompting selection of the space to be used among the spaces are displayed. Further, on the use fee presentation screen according to the present exemplary embodiment, a selection designation area 25Q and a selection designation area 25R for selecting each space are displayed. In a case where the use fee presentation screen illustrated in FIG. 19 as an example is displayed on the display unit 25, the target user selects the selection designation area 25Q or the selection designation area 25R via the input unit 24. With this selection, in a case where the target user gives priority to the use fee of the available space, it is possible to designate (grasp) whether the space with the high use fee is requested or the space with the low use fee is requested.

In step S429, the CPU 11 reads a use fee corresponding to the available space from the spatial information database 13G, and sets the recommendation degree to a higher degree as the use fee is closer to the use fee of the space selected on the use fee presentation screen, and proceeds to step S446.

In step S435, the CPU 11 controls the display unit 25 to display a distance presentation screen in a predetermined format.

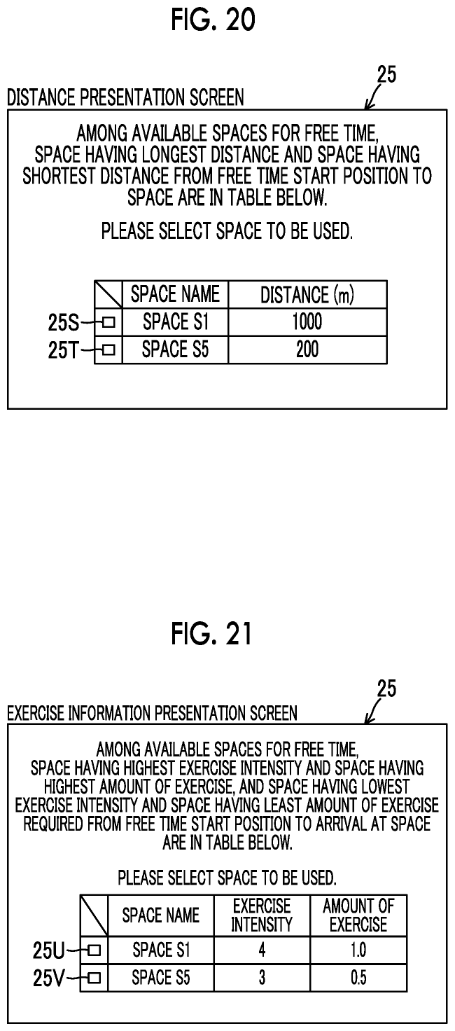

As illustrated in FIG. 20, on the distance presentation screen according to the present exemplary embodiment, information indicating names of a space having the longest distance and a space having the shortest distance from the free time start position to the available space, and the distances, and a message prompting selection of the space to be used among the spaces are displayed. Further, on the distance presentation screen according to the present exemplary embodiment, a selection designation area 25S and a selection designation area 25T for selecting each space are displayed. In a case where the distance presentation screen illustrated in FIG. 20 as an example is displayed on the display unit 25, the target user selects the selection designation area 25S or the selection designation area 25I via the input unit 24. With this selection, in a case where the target user gives priority to the distance, it is possible to designate (grasp) whether the space having the long distance is requested or the space having the short distance is requested.

In step S437, the CPU 11 reads an address corresponding to the available space from the spatial information database 13G, sets the recommendation degree to a higher degree as a movement distance from the free time start position to the address is closer to the movement distance from the free time start position to the space selected on the distance presentation screen, and proceeds to step S446.

In step S439, the CPU 11 controls the display unit 25 to display an exercise information presentation screen in a predetermined format.

As illustrated in FIG. 21, on the exercise information presentation screen according to the present exemplary embodiment, information indicating names of a space having the highest exercise intensity or the highest amount of exercise and a space having the lowest exercise intensity or the least amount of exercise required from the free time start position to an arrival at the available space, and the exercise information, and a message prompting the selection of the space to be used from the spaces are displayed. Further, on the exercise information presentation screen according to the present exemplary embodiment, a selection designation area 25U and a selection designation area 25V for selecting each space are displayed. In a case where the exercise information presentation screen illustrated in FIG. 21 as an example is displayed on the display unit 25, the target user selects the selection designation area 25U or the selection designation area 25V via the input unit 24. With this selection, in a case where the target user gives priority to exercise intensity or exercise amount, it is possible to designate (grasp) the space having the high exercise intensity or the large amount of exercise, or the space having the low exercise intensity or the small amount of exercise.

In step S441, the CPU 11 reads an address corresponding to the available space from the spatial information database 13G, sets the recommendation degree to a higher degree as the exercise intensity or the amount of exercise required from the free time start position to an arrival at the space is closer to the exercise intensity or the amount of exercise required from the free time start position to an arrive at the space selected on the exercise information presentation screen, and proceeds to step S446.

In step S443, the CPU 11 controls the display unit 25 to display a reserved-people number presentation screen in a predetermined format.

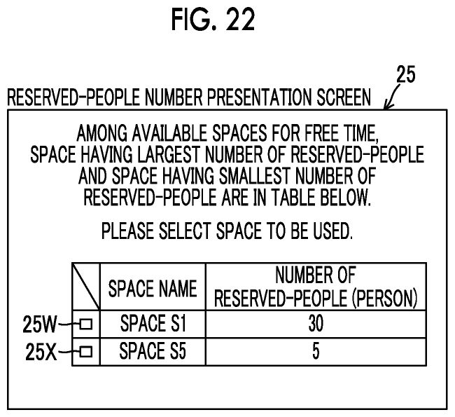

As illustrated in FIG. 22, on the reserved-people number presentation screen according to the present exemplary embodiment, information indicating names of a space having the largest number of reserved-people and a space having the smallest number of reserved-people among the available spaces, and the number of reserved-people, and a message prompting selection of a space to be used among the spaces are displayed. Further, on the reserved-people number presentation screen according to the present exemplary embodiment, a selection designation area 25W and a selection designation area 25X for selecting each space are displayed. In a case where the reserved-people number presentation screen illustrated in FIG. 22 as an example is displayed on the display unit 25, the target user selects the selection designation area 25W or the selection designation area 25X via the input unit 24. With this selection, in a case where the target user gives priority to the number of reserved-people, it is possible to designate (grasp) whether the space having the large number of reserved-people is requested or the space having the small number of reserved-people is requested.

In step S445, the CPU 11 reads the number of reserved-people corresponding to the available space from the reservation information database 13D, sets the recommendation degree to a higher degree as the number of reserved-people is closer to the number of reserved-people for the space selected on the reserved-people number presentation screen, and proceeds to step S446.

Although the exemplary embodiments are described above, a technical scope of the exemplary embodiments of the present invention is not limited to the scope described in the exemplary embodiments described above. Various modifications or improvements can be added to the exemplary embodiment without departing from the gist of the present exemplary embodiment of the invention and the modified or improved form is also included in the technical scope of the present exemplary embodiment of the invention.

Further, the exemplary embodiments described above do not limit the invention according to the claim, and not all combinations of features described in the exemplary embodiment are fundamental to the exemplary embodiment of the invention. The exemplary embodiments described above include exemplary embodiments of the inventions at various stages, and various exemplary embodiments of the invention are extracted by combining a plurality of disclosed components. Even in a case where some components are deleted from all the components described in the exemplary embodiment, a configuration in which some of the components are deleted can be extracted as an exemplary embodiment of the invention as long as the effect is obtained.

For example, as the above recommendation degree, in a case where rainy weather is expected at the free time start position by using weather information provided by Japan Meteorological Agency or the like, the shorter the outdoor movement distance from the free time start position to the space, the higher the degree may be applied.

In a case where the CPU 11 does not include a predetermined type of object such as a dangerous substance having volatile and toxic properties in the baggage brought by the target user, in addition to the presentation of the space, a mode may be applied in which a baggage storage at which a distance to the space is within a predetermined distance is further presented. Further, the CPU 11 may apply a mode in which the baggage storage to be presented is determined according to a type of baggage brought by the target user.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

Further, in the exemplary embodiments described above, the case where the information processing program 13A is installed in advance in the storage unit 13 is described, but the exemplary embodiment is not limited thereto. For example, the information processing program 13A may be stored in a storage medium such as a compact disc read only memory (CD-ROM) and provided, or may be provided via a network.

Further, in the exemplary embodiment described above, the case where the use process and the information process are realized by the software configuration using a computer by executing the program is described, but the exemplary embodiment is not limited thereto. For example, at least one of the use process and the information process may be realized by a hardware configuration or a combination of the hardware configuration and a software configuration.

In addition, the configuration of the information processing system 100 described in the exemplary embodiment described above (see FIGS. 1 and 2) is an example, and unnecessary components may be deleted or new components may be added without departing from the gist of the exemplary embodiment.

Further, the flow of information processing (see FIG. 11) and the flow of the presentation space determination process (see FIGS. 12 and 17) described in the exemplary embodiment described above are also examples, and unnecessary steps may be deleted, new steps may be added, or the processing order may be changed without departing from the gist of the exemplary embodiment.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to
acquire a free time occurring since a point in time at which a user starts moving toward a destination point until a target job is started at the destination point; and
perform control of presenting an available space for the free time in a case where the free time is equal to or longer than a predetermined time.

2. The information processing apparatus according to claim 1,
wherein the processor is configured to:
determine the space to be presented, according to a recommendation degree of the space in a case where there are a plurality of the spaces.

3. The information processing apparatus according to claim 2,
wherein the recommendation degree is a degree determined according to a most recent transportation means until the free time occurs.

4. The information processing apparatus according to claim 2,
wherein the recommendation degree is a degree determined according to a time at which the space is available to the user.

5. The information processing apparatus according to claim 2,
wherein the recommendation degree is a degree determined according to a distance between a position of the user at a point in time at which the free time occurs and the space.

6. The information processing apparatus according to claim 2,
wherein the recommendation degree is a degree determined according to an exercise intensity or an amount of exercise of the user required to arrive at the space.

7. The information processing apparatus according to claim 2,
wherein the recommendation degree is a degree determined according to a use fee for the space.

8. The information processing apparatus according to claim 2,
wherein the recommendation degree is a degree determined according to the number of users for the space expected at a point in time at which the user arrives at the space.

9. The information processing apparatus according to claim 2,
wherein the recommendation degree is a degree determined according to an attribute of the user.

10. The information processing apparatus according to claim 2,
wherein the recommendation degree is a degree determined according to the number of the users.

11. The information processing apparatus according to claim 2,
wherein the recommendation degree is a degree determined according to an occurrence situation of traffic congestion until the free time occurs.

12. The information processing apparatus according to claim 2,
wherein in a case where the space is presented as a business and there is a facility which brings a profit to a business operator doing the business, the recommendation degree is a degree determined according to a distance between the facility and the space.

13. The information processing apparatus according to claim 2,
wherein in a case where the space is presented as a business and there is a facility which brings a profit to a business operator doing the business, the recommendation degree is a degree determined according to a magnitude of the profit.

14. The information processing apparatus according to claim 1,
wherein the processor is configured to:
further receive selection of a condition for the space from the user in a case where there are a plurality of the spaces; and
determine the space to be presented according to the received selection.

15. The information processing apparatus according to claim 1,
wherein the processor is configured to:
further present a baggage storage at which a distance to the space is within a predetermined distance, in addition to presentation of the space, in a case where a predetermined condition is satisfied.

16. The information processing apparatus according to claim 15,
wherein the predetermined condition is a condition that a distance between the destination point and a departure point departing for the destination point is equal to or greater than a predetermined distance.

17. The information processing apparatus according to claim 15,
wherein the predetermined condition is a condition that an attribute of the user is a predetermined attribute.

18. The information processing apparatus according to claim 1,
wherein the processor is configured to:
receive a reservation for the space from the user according to the presentation of the space; and
further perform a process of validating the reservation for the space by the user in a case where the reservation is received.

19. The information processing apparatus according to claim 1,
wherein the processor is configured to:
perform control of further presenting a way to the space.

20. A non-transitory computer readable medium storing an information processing program causing a computer to execute a process, the process comprising:
acquiring a free time occurring since a point in time at which a user starts moving toward a destination point until a target job is started at the destination point; and
performing control of presenting an available space for the free time in a case where the free time is equal to or longer than a predetermined time.
